(19) United States
(12) Patent Application Publication
(10) Pub. No.: US 2010/0127589 A1
(43) Pub. Date: May 27, 2010

(54) BEARING DEVICE HAVING A SHAFT WHICH IS MOUNTED MAGNETICALLY SUCH THAT IT CAN ROTATE ABOUT AN AXIS WITH RESPECT TO A STATOR, AND HAVING A DAMPING APPARATUS

(75) Inventor: Peter Kummeth, Herzogenaurach (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Munchen (DE)

(21) Appl. No.: 12/597,214

(22) PCT Filed: Apr. 17, 2008
(86) PCT No.: PCT/EP08/54677

§ 371 Date: Oct. 23, 2009

(30) Foreign Application Priority Data
Apr. 25, 2007 (DE) 10 2007 019 766.9

(51) Int. Cl. H02K 7/09

(52) U.S. Cl. 310/90.5

(57) ABSTRACT

The invention relates to a bearing device (100) having a magnetic bearing (210) for mounting a shaft (101) and a damping device (200). The damping device (200) comprises a first disc-shaped damper part (201) that is part of the shaft (101), and a yoke-shaped second damper part (202) that comprises side parts (211) guiding the magnetic flow and means (212) for producing a magnetic field. The side parts (211) guiding the magnetic flow are disposed at a distance from one another to form an annular-cylindrical intermediate chamber in the axial direction relative to the axis (A). The first damper part (201) protrudes into said intermediate chamber in a radial fashion relative to the axis (A). The second damper part (202) completely surrounds the disc-shaped first damper part (201). The side parts (211) guiding the magnetic flow are provided on their sides facing the first damping part (201) with dentoid extensions that are rotationally symmetrical relative to the axis (A) for producing a non-homogenous magnetic field in the annular-cylindrical intermediate chamber in the radial direction relative to the axis (A).

The invention relates to a bearing device having a shaft which is mounted magnetically such that it can rotate about an axis with respect to a stator. A bearing device such as this is disclosed, for example, in DE 10 2005 028 209 A1.

Magnetic bearing devices allow non-contacting and wear-free bearing of moving parts. They do not require any lubricants and can be designed with low friction. Magnetic bearing devices such as these are used, for example, for turbomolecular pumps, ultracentrifuges, high-speed spindles of machine tools and X-ray tubes with rotating anodes. Furthermore, magnetic bearings are used for turbines and compressors, but in particular also for motors and generators.

A magnetic bearing device may allow radial and/or axial bearing of a rotating shaft with respect to a stator. The magnetic-field-producing means which are required for the magnetic bearing of a shaft can be provided by the windings of an electromagnet or else by permanent magnets. The magnetic-field-producing means may be both part of the rotating part of a magnetic bearing device and part of the stator of a device such as this.

Active magnetic bearing devices are generally known from the prior art. In the case of active bearing devices, the magnetic forces which are required for the axial and/or radial magnetic bearing of a shaft are controlled by a regulation device. An active magnetic bearing such as this is disclosed, for example, in DE 38 44 563 A1. Furthermore, magnetic bearing devices are known which are, for example, intrinsically stable in a radial direction with respect to a rotation axis of the magnetically borne shaft. Passive magnetic bearings such as these may comprise a plurality of rotor disk elements which are arranged one behind the other on a shaft in the direction of the rotation axis and are separated from one another, forming an intermediate space. In the case of a bearing such as this, stator disk elements which are connected to the shaft can engage in the intermediate spaces between the rotor disk elements. The rotor disk elements and the stator disk elements can be provided with a toothed structure, on their mutually opposite surfaces, in order to provide radial self-stabilization for the bearing. By way of example, a bearing such as this is disclosed in DE 10 2005 028 209 A1.

Further passive magnetic bearings which are known from the prior art are superconducting magnetic bearings. In the case of a superconducting magnetic bearing, one of the two bearing parts is formed by permanent-magnetic elements, and the other bearing part comprises a superconductor. The permanent-magnetic elements induce field changes at the location of the superconductor, when a position change occurs. Shield currents are induced in the superconductor by the varying fields. The resultant forces which are caused by the shield currents may be both attractive and repulsive. However, they are always directed such that they counteract any deflection from the nominal position. This results in an inherently stable bearing being produced, and there is no need for complex regulation, which may be subject to faults. A superconducting magnetic bearing such as this is disclosed, for example, in DE 101 24 193 A1.

Both conventional and superconducting magnetic bearings have little damping of the bearing shaft with respect to the stator, by virtue of their design. In particular, high-quality superconducting magnetic bearings, for which superconducting material with a high critical current density is used, have particularly light damping, which is virtually negligible.

Magnetic bearing devices can be used for the bearing of motor shafts or generator shafts, or for the bearing of other high-speed machines. High rotation speeds of a bearing such as this, resulting from the field of operation, are frequently in a so-called supercritical range. In this case, the expression a supercritical range means the rotation speed range of a bearing which is above the resonant frequency or the resonant frequencies of the bearing. Starting from a stationary bearing shaft, as the rotation speed of a magnetic bearing such as this rises, it is necessary to pass through the resonant frequency or the resonant frequencies of the bearing. The bearing shaft oscillations which typically occur in the region of the resonant frequencies, as known from the prior art, are suppressed by means of mechanical back-up bearings.

The object of the present invention is to specify a bearing device which is better than the solutions known from the prior art in terms of the damping of a magnetically borne shaft.

This object is achieved by the measures specified in the independent claims 1 and 7.

The invention is in this case based on the idea of using the eddy-current losses produced in a conductive material by a varying magnetic field to damp a shaft in a magnetic bearing.

The invention is also based on the idea of producing a magnetic field which is rotationally symmetrical with respect to a rotation axis of a shaft of a magnetic bearing and is inhomogeneous in a direction radially with respect to the rotation axis of the shaft. A further aim is to subject an electrically highly conductive component to a magnetic field such as this.

The component and the already described magnetic field are also intended to rotate with respect to one another. When the component rotates about a fixed rotation axis, no eddy currents are induced in it. In contrast, if the component moves away from the predetermined rotation axis, then eddy currents are induced in the component since the magnetic field to which the component is subject is inhomogeneous in the radial direction. These eddy currents result in a damping force effect on the component, pointing in a direction at right angles to its rotation axis.

If an electrically highly conductive component which is subjected to an inhomogeneous magnetic field as described above is now selectively connected either to a rotating part or to a static part of a magnetic bearing, and if a corresponding further component which produces an inhomogeneous magnetic field is also selectively connected to a rotating part or to a static part of a magnetic bearing, then a non-contacting damping device can be specified.

According to the invention, a bearing device is specified having a shaft which is mounted magnetically such that it can rotate about an axis with respect to a stator, and having a damping apparatus wherein the damping apparatus is intended to comprise at least one first damper part, which is arranged at right angles to the axis, is in the form of a disk and is part of the shaft, and at least one yoke body as a second damper part, which is part of the stator. The yoke body is furthermore intended to comprise magnetic-field-producing means and two magnetic-flux-guiding side parts, which are separated from one another, forming an annular cylindrical intermediate space, in an axial direction with respect to the axis. The first damper part projects into the annular cylindrical intermediate space between the side parts in the radial direction with respect to the axis. The second damper part completely surrounds the first damper part, which is in the form of a disk, in the circumferential direction. The side parts of the second damper part are intended to have tooth-like projections on their sides facing the first damper part, in order to produce a magnetic field, which is inhomogeneous in the radial direction with respect to the axis, in the annular cylindrical intermediate space.

Furthermore, according to the invention, it is intended to specify a bearing device having a shaft, which is mounted magnetically such that it can rotate about an axis with respect to a stator, and having a damping apparatus, wherein the damping apparatus comprises at least one first damper part, which is arranged at right angles to the axis, is in the form of a perforated disk and is part of the stator, and at least one yoke body as a second damper part, which is mechanically connected to the shaft. The second damper part is furthermore intended to have magnetic-field-producing means and two magnetic-flux-guiding side parts, which are separated from one another, forming an annular cylindrical intermediate space, in an axial direction with respect to the axis. The first damper part is intended to project into the annular cylindrical intermediate space in the radial direction with respect to the axis, and is intended to completely surround the second damper part, by the shape of a yoke body, in the circumferential direction. The side parts of the second damper part are intended to have tooth-like projections on their sides facing the first damper part, in order to produce a magnetic field, which is inhomogeneous in the radial direction with respect to the axis, in the annular cylindrical intermediate space.

The advantages of the bearing device according to the invention are, in particular, that a bearing device is made possible having a damping apparatus according to the invention, allowing non-contacting damping of a magnetically borne shaft. In consequence, a magnetically borne shaft can be damped in such a way that there is no need for any further components which are mechanically connected to the shaft. Thus, according to the invention, a bearing device can be specified which requires little maintenance, is subject to little wear and has a damping apparatus which likewise requires little maintenance and is subject to little wear.

Advantageous refinements of the abovementioned bearing devices are specified in claims 2 to 6, which are dependent on claim 1, and in claims 8 and 9, which are dependent on claim 7, as well as in the dependent claims 10 to 19. In this case, the embodiment as claimed in claim 1 or claim 7 may in particular be combined with the features of one or preferably also those of a plurality of dependent claims. The bearing device according to the invention can accordingly also have the following features:
The magnetic-field-producing means may be formed by the winding of an electromagnet. Magnetic-field-producing means in the form of the winding of an electromagnet can be produced easily, require little maintenance and are reliable.
The magnetic bearing may have a regulation apparatus in order to control a field current of the electromagnet. Regulation of the field current makes it possible to adjust a damping constant of the damping apparatus. Adjusting the damping constants of the damping apparatus allows the damping of the magnetic bearing to be adjusted in accordance with the respectively desired requirements. The field of application of the magnetic bearing can thus advantageously be extended.
The damping constant can be regulated as a function of the rotation speed of the bearing device. Regulation of the damping constants as a function of the rotation speed makes it possible to operate the magnetic bearing with different damping constants in different fields of use.
The damping constant can also assume a predetermined value, in order to suppress resonant oscillations of the bearing device, at one specific rotation speed or at a plurality of specific rotation speeds of the bearing device, which are located in the region of the resonant frequency or the resonant frequencies of the bearing device. The occurrence of resonant oscillations can advantageously be suppressed by setting a predetermined value of the damping constant.
The magnetic-field-producing means may be arranged on the radially outer edge area of the second damper part, between the two side parts. An arrangement of the magnetic-field-producing means such as this represents a particularly simple and space-saving embodiment.
The second bearing part can be mechanically connected to the shaft and can be magnetically separated from the shaft via non-magnetic reinforcement. Furthermore, the shaft may be formed from non-magnetic material. A magnetic short between the two side parts of the second damper part can advantageously be avoided by connection of the second bearing part by means of a non-magnetic reinforcement and by the shaft being formed from a non-magnetic material.
The magnetic-field-producing means may be formed by at least one permanent magnet. Furthermore, this permanent magnet may be a ring magnet which surrounds the shaft. Alternatively, the magnetic-field-producing means may be formed by an arrangement of individual magnets which, together with the side parts, form a closed magnetic arrangement which surrounds the shaft in the circumferential direction of the side parts. The abovementioned embodiments indicate particularly simple and effective measures for configuration of the magnetic-field-producing means.
The material of the permanent magnets may contain neodymium, iron and boron. Permanent magnets which are produced using neodymium, iron and boron have a hard-magnetic behavior and are therefore particularly suitable for the damping apparatus of a bearing device.
The magnetic-field-producing means may be a component of the two side parts. In particular, the magnetic-field-producing means may be integrated in the two side parts in the form of magnets which are in the form of disks. The abovementioned measures make it possible to specify a particularly space-saving damping device.
The bearing device may have superconducting material which is used for the magnetic bearing of the shaft with respect to the stator. The superconducting material may also be low-temperature or high-temperature superconducting material. Superconductive magnetic bearings are distinguished by particularly low-loss magnetic bearing. Effective and non-contacting damping of a shaft of a superconducting magnetic bearing is therefore particularly advantageous.
The tooth-like projections may have a trapezoidal cross section. A magnetic field which is inhomogeneous in the radial direction can be produced particularly easily and effectively by means of trapezoidal tooth-like projections.
The first damper part may be composed predominantly of copper or aluminum. Furthermore, the second damper part may be composed predominantly of iron or steel. A particularly simple and effective embodiment of the damping device can be specified by the first damper part, which is in the form of a disk, and/or the second damper part, which is in the form of a yoke, being formed from one of the abovementioned materials.

Further advantageous refinements of the bearing device according to the invention will become evident from the claims which have not been addressed above and in particular from the drawing, which will be explained in the following text, and in which:

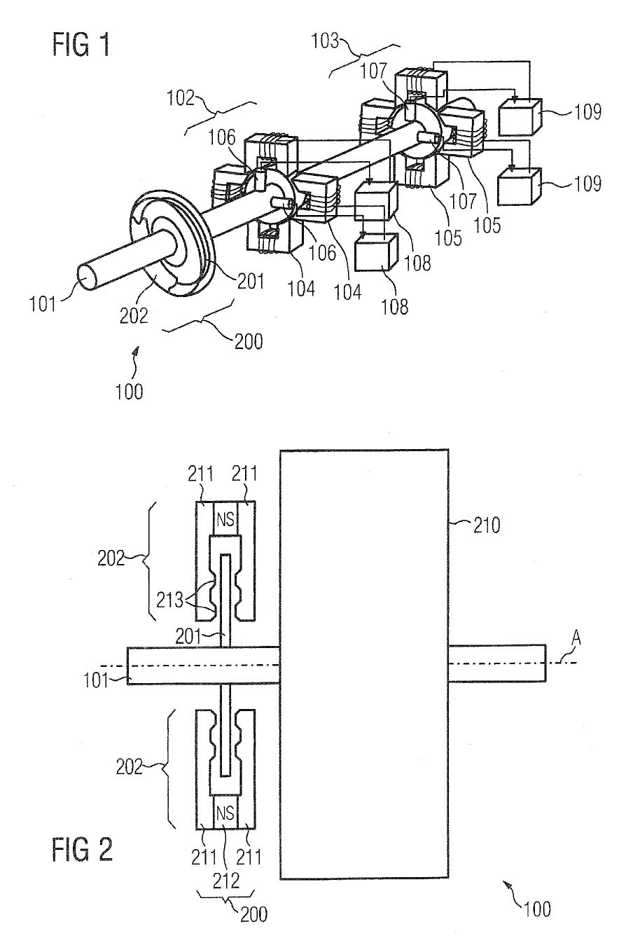

FIG. 1 shows a perspective view of an active magnetic bearing with a damping device,

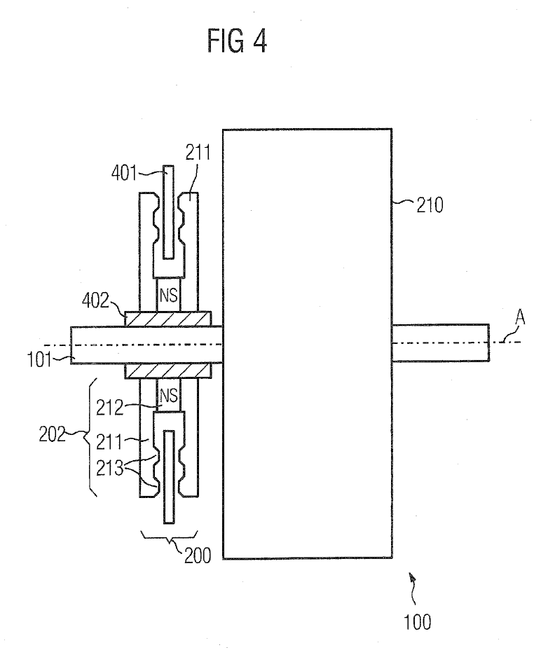

FIGS. 2 and 4 show a magnetic bearing with a damping device,

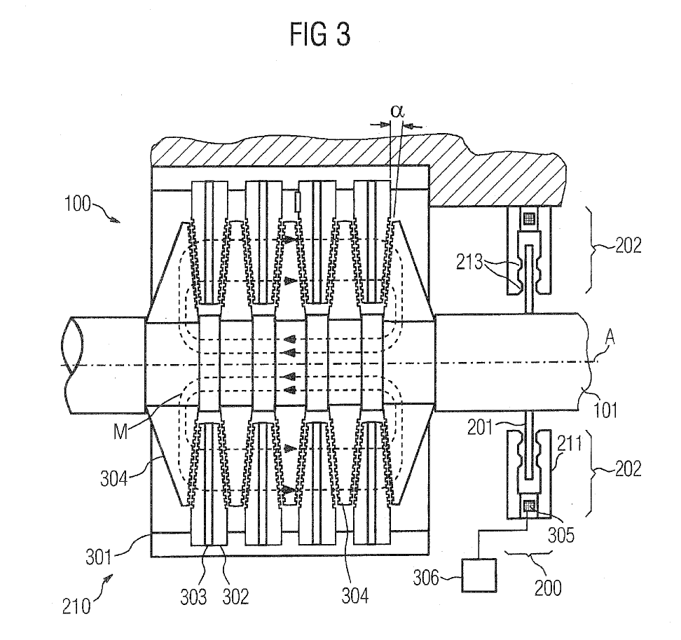

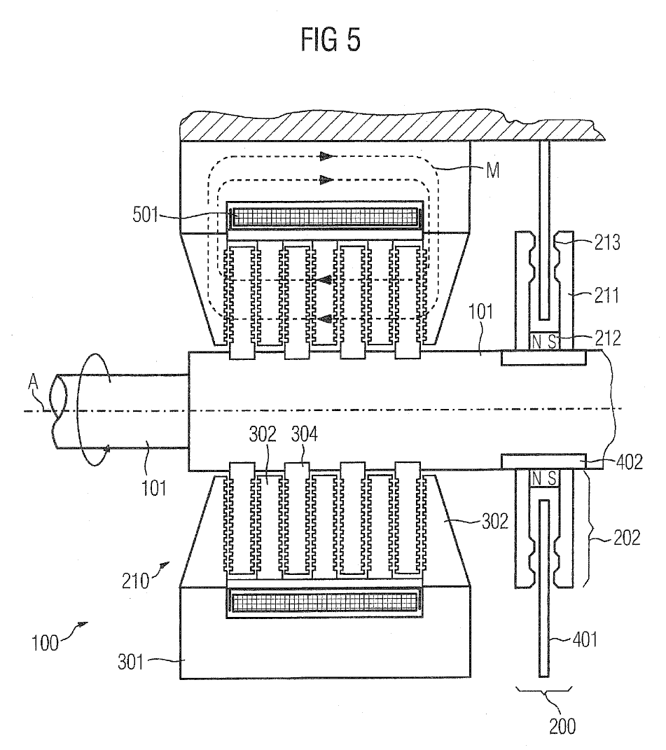

FIGS. 3 and 5 show a radially intrinsically stable magnetic bearing with a damping apparatus, and

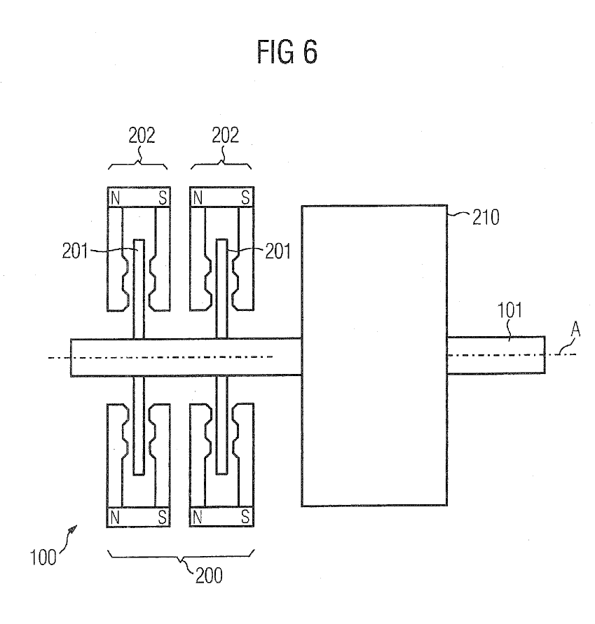

FIG. 6 shows a magnetic bearing with a duplicated damping apparatus.

FIG. 1 shows a bearing device 100 in which a shaft 101 is mounted by means of two active radial bearings 102, 103 such that it can rotate. The active radial bearings 102, 103 have respective electromagnets 104, 105 which allow active bearing of the shaft 101 using distance sensors 106, 107 and a suitable regulation device 108, 109. Furthermore, the illustrated bearing device 100 has a damping apparatus 200, which comprises a first damper part 201, which is in the form of a disk, and a second damper part 202, which is in the form of a yoke. The first damper part 201, which is in the form of a disk, is mechanically connected to the shaft 101 or is formed as a part of the shaft 101. The first damper part 201, which is in the form of a disk, is also oriented at right angles to the axis A of the shaft 101. The first damper part 201, which is in the form of a disk, is completely surrounded in the circumferential direction by the second damper part 202, which is in the form of a yoke. For clarity reasons, the second damper part 202, which is in the form of a yoke, is illustrated cut away in its edge area.

FIG. 2 shows the cross-sectional view of a bearing device 100 with a schematically illustrated magnetic bearing 210 and a damping apparatus 200. The magnetic bearing 210 may be a conventional magnetic bearing, for example an actively regulated magnetic bearing. The magnetic bearing 210 may likewise be a further magnetic bearing which is known from the prior art, for example a superconducting magnetic bearing. A shaft 101 is borne by means of the magnetic bearing 210 such that it can rotate about an axis A.

The damping apparatus 200 has a first damper part 201, which is in the form of a disk and is connected to the shaft 101. The first damper part 201, which is in the form of a disk, may be a disk composed of highly conductive material, for example composed of copper or aluminum. The first damper part 201, which is in form of a disk, may, for example, be connected to the shaft 101 by means, for example, of a ring clamping element. The first damper part 201, which is in the form of a disk, may also have a virtually circular shape.

The first damper part 201, which is in the form of a disk, is completely surrounded in the circumferential direction by a second damper part 202, which is in the form of a yoke. The second damper part 202 may also be manufactured predominantly from iron or steel. Further materials which are suitable for magnetic flux guidance may likewise be used. The second damper part 202 has one or more permanent magnets 212 as the magnetic-field-producing means. By way of example, the permanent magnets 212 may be permanent magnets which contain neodymium, iron and boron. Furthermore, the permanent magnets 212 may be closed, annular magnets which surround the axis 101. Alternatively, the magnetic-field-producing means may be formed by an arrangement composed of discrete, individual magnets which are separate from one another, with the individual discrete magnets together with the side parts 211 forming a magnetic arrangement which is closed in the circumferential direction of the side parts 211.

Magnetic-flux-guiding side parts 211 are arranged on both sides of the permanent magnet 212 as part of the damping apparatus 200 and have tooth-like projections 213 on their sides which face the first damping part 201, which is in the form of a disk. The magnetic-flux-guiding side parts 211 may be in the form of a perforated disk, which is oriented at right angles to the axis A.

In order to simplify assembly, the first damper part 201, which is in the form of a disk, may likewise be a component which is assembled from a plurality of segments. For example, the first damper part 201, which is in the form of a disk, may be composed of two elements which are in the form of half-disks and are separated along a plane on which the axis A lies. Furthermore, the first damper part 201, which is in the form of a disk, may be composed of a multiplicity of disk segments.

The permanent magnet or permanent magnets 212 produces or produce a magnetic flux in the side parts 211 which is focused by the tooth-like projections 213 and leads to a magnetic field distribution, which is inhomogeneous with respect to the axis A in a radial direction, in the annular cylindrical air gap between the side parts 211. The magnetic flux passes through the first damper part 201, which is connected to the shaft 101, is in the form of a disk and projects into the annular cylindrical intermediate space, and flows back to the magnetic-field-producing permanent magnet 212 via the corresponding side part 211 on the opposite side. The tooth-like projections 213 on the side parts 211 are radially symmetrical with respect to the axis A.

As an alternative to a configuration with a plurality of tooth-like projections which are radially symmetrical and are concentric with respect to the axis A, the magnetic-flux-guiding side parts 211 may have only one tooth-like projection, which is concentric with respect to the axis A. The tooth-like projections 213 may have a trapezoidal shape, when viewed in the form of a cross section.

When the shaft 101 rotates about the axis A, then the inhomogeneous magnetic field which is present in the gap between the side parts 211 in the radial direction with respect to the axis A results, since this is rotationally symmetrical with respect to rotation about the axis A, with no eddy currents being induced in the first damper part 201, which is in the form of a disk. This is the case because no magnetic field changes occur at the location of the first damper part, which is in the form of a disk, at the location of the first damper part 201, which is in the form of a disk, when the first damper part 201 rotates about the axis A.

In contrast, when the shaft 101 moves radially, the first damper part 201, which is in the form of a disk, is moved in a radial direction with respect to the axis A in the inhomogeneous magnetic field. A movement of the first damper part 201, which is in the form of a disk, such as this in the inhomogeneous magnetic field between the side parts 211 results in eddy currents being induced in the first damper part 201, which is in the form of a disk. The eddy-current losses caused by these eddy currents lead to damping of the movement of the shaft 101.

FIG. 3 shows a bearing device 100 according to a further exemplary embodiment. The bearing device 100 has a magnetic bearing 210 and a damping apparatus 200.

The magnetic bearing 210 is a passive magnetic bearing which is intrinsically stable in the radial direction. The magnetic bearing 210 has a stator 301 with stator disk elements 302 which are arranged at right angles to the axis A and are at a distance from one another in the direction of the axis A, forming the intermediate space. Permanent-magnetic elements 303 are integrated in the stator disk elements 302 and are used to produce a magnetic holding flux M in order to bear the shaft 101. A rotor disk element 304 projects into each of the intermediate spaces between the stator disk elements 302. The stator disk elements 302 and the rotor disk elements 304 are each provided with tooth-like projections on their mutually facing sides. These tooth-like projections lead to an inhomogeneous magnetic field distribution in the bearing gap of the magnetic bearing 210, between the stator disk elements 302 and the rotor disk elements 304. This inhomogeneous magnetic field distribution in the bearing gap of the magnetic bearing 210 leads to the magnetic bearing 210 being intrinsically stable in the radial direction with respect to the axis A. Furthermore, the surfaces of the stator disk elements 302 and of the rotor disk elements 304 can be inclined at an angle a with respect to the axis A.

The damping apparatus 200 has a first damper part 201, which is in the form of a disk and is connected to the shaft 101, which is mounted such that it can rotate, and is surrounded completely along its circumference by a second damper part 302, which is in the form of a yoke. The second damper part 202, which is in the form of a yoke, may also be mechanically connected to the stator 301 of the magnetic bearing 210.

The second damper part 202, which is in the form of a yoke, comprises two side parts 211 which have tooth-like projections 213 on their sides facing the first damper part 201, which is in the form of a disk. Furthermore, the second damper part 202, which is in the form of a yoke, has magnetic-field-producing means in the form of a magnet winding 305. The magnet winding 305 of the damping apparatus 200 may be located on the radially outer edge area of the second damper part 202, which is in the form of a yoke. A magnetic flux can be produced by means of the magnet winding 305, and is forced away via the tooth-like projections 213 and the first damper part 201, which is in the form of a disk and is arranged between the side parts 211. In addition, the magnet winding 305 may be connected to a regulation apparatus 306 for regulation of the field current of the magnet winding 305. In particular, a damping constant of the damping apparatus 200 can be adjusted by means of the regulation apparatus 306, via the field current of the magnet winding 305. This damping constant may also be regulated as a function of the rotation speed of the shaft 101. For example, a higher damping constant can be set for the damping device 200 when the rotation speed of the shaft 101 is higher.

A magnet bearing typically has one or more resonant frequencies. The magnet winding 305 can now be excited by means of the regulation apparatus 306 such that the damping constant of the damping device 200 is set to a specific value at rotation speeds of the shaft 101 which lie in the region of the resonant frequency or the resonant frequencies of the magnetic bearing 210. This means that it is possible to pass through the resonant frequency or the resonant frequencies of the magnetic bearing 210 when the rotation speed of the shaft 101 is being accelerated from rest such a way that resonant oscillations in the bearing device 210 are reduced.

FIG. 4 shows a further bearing device 100. The bearing device 100 has a magnetic bearing 210 and a damping apparatus 200. The magnetic bearing 210 may be a conventional magnetic bearing which is known in a general form from the prior art, or else may, in particular, be a superconducting magnetic bearing.

The damping apparatus 200 has a first damper part 401, which is in the form of a perforated disk, is mounted in a fixed position and can be mechanically connected, for example, to a stator of the magnetic bearing 210. The first damper part 401, which is in the form of a perforated disk, can be oriented at right angles to the axis A. The first damper part 401, which is in the form of a perforated disk, completely surrounds a second damper part 202, which is in the form of a yoke, in the circumferential direction.

The second damper part 202, which is in the form of a yoke, comprises two magnetic-flux-guiding side parts 211 which have tooth-like projections 213 on their sides facing the first damper part 401, which is in the form of a perforated disk. Furthermore, the second damper part 202, which is in the form of a yoke, has one or more permanent-magnetic elements 212 which can be arranged on the radially inner edge of the side parts 211 which are in the form of disks. The permanent-magnetic elements 212 may be a ring magnet which completely surrounds the shaft 101 or else an arrangement composed of discrete permanent magnets 212 which are separated from one another and, together with the side parts 211, form a closed magnetic arrangement.

The permanent-magnetic elements 212 may be magnetically separated from the shaft 101 by means of non-magnetic reinforcement 402. At the same time, the second damper part 202, which is in the form of a yoke, is mechanically connected to the shaft 101 by means of the non-magnetic reinforcement 402.

The method of operation of the damper device 200, of the bearing device 100 which is illustrated in FIG. 4, should be understood analogously to the statements made in conjunction with FIG. 2.

The permanent magnets 212 may also be an integrated component of the side parts 211. For example, the permanent magnets can likewise be in the form of disks and may be integrated in the side parts 211.

FIG. 5 shows a bearing device 100 according to a further exemplary embodiment. The illustrated bearing device 100 comprises a magnetic bearing 210 and a damping apparatus 200.

The magnetic bearing 210 has a stator 301 which comprises stator disk elements 302 which are arranged at right angles to the axis A of the shaft 101. Rotor disk elements 304 which are connected to the shaft 101 project into the intermediate spaces between the stator disk elements 302. The stator disk elements 302 and the rotor disk elements 304 are provided with tooth-like projections on their mutually facing sides. Because of these tooth-like projections, the illustrated magnetic bearing 210 is intrinsically stable in the radial direction with respect to the axis A, in a similar manner to the magnetic bearing 210 illustrated in FIG. 3. The magnetic bearing 210 has a magnet winding 501, which is integrated in the stator 301, in order to produce a magnetic holding flux M.

The damping device 200 has a first damper part 401 which is in the form of a perforated disk and completely surrounds a second damper part 202, which is in the form of a yoke. The first damper part 401, which is in the form of a perforated disk, can be manufactured, for example, from two separate half-disks, for easier assembly. The second damper part 202, which is in the form of a yoke, also has side parts 211 which have tooth-like projections 213 on their sides facing the first damper part 401, which is in the form of a perforated disk. As magnetic-field-producing means, the second damper part 202, which is in the form of a yoke, may have permanent magnets 212 which are arranged on the radially inner edge of the second damper part 202, which is in the form of a yoke. The second damper part 202 is mechanically connected to the shaft 101 and can be magnetically separated from it by reinforcement 402. The non-magnetic reinforcement 402 can be incorporated in the shaft 101. Furthermore, the shaft 101 may be manufactured from a non-magnetic material. The first damper part 401, which is in the form of perforated disk, may also be mechanically connected to a static part of the magnetic bearing 210, and for example the first damper part 401, which is in the form of a perforated disk, may be mechanically connected to the stator 301.

FIG. 6 shows a bearing device with a magnetic bearing 210 and a damping apparatus 200 according to a further exemplary embodiment. The magnetic bearing 210 may be a conventional active or passive magnetic bearing, and likewise a superconducting magnetic bearing.

The damping apparatus 200 is duplicated and it therefore has two first damper parts 201, which are in the form of disks, and, in a corresponding manner, two second damper parts 202, which are in the form of yokes. In general, the damping device 200 can be designed, with the first damper parts 210 which are in the form of disks and with the second damper parts 202 which are in the form of yokes, analogously to the exemplary embodiment shown in FIG. 2, taking account of the respectively duplicated form of the first damper part 201 and of the second damper part 202. Duplication of the damping device 200 makes it possible to increase the damping of the shaft 101 in comparison to a single version. Furthermore, the damping device 200 may be more than duplicated and, for example, may comprise three or more damper elements, each comprising a first damper part 201, which is in the form of a disk, and a second damper part 202, which is in the form of a yoke.

1.-19. (canceled)

20. A bearing device comprising:
a shaft magnetically supported for rotation about a rotation axis with respect to a stator, and
a damping apparatus including:
at least one disk-shaped first damper part arranged perpendicular to the rotation axis and forming part of the shaft, and
at least one yoke body forming a second damper part and being part of the stator, said second damper part completely surrounding the first damper part in a circumferential direction and including magnetic-field-producing means, and two magnetic-flux-guiding side parts, which are spaced from one another in an axial direction with respect to the rotation axis and form an annular cylindrical intermediate space, said side parts having on their sides facing the first damper part tooth-like projections, which are rotationally symmetrical with respect to the rotation axis, said tooth-like projections producing in the annular cylindrical intermediate space a magnetic field that is inhomogeneous in a radial direction with respect to the rotation axis,
wherein the first damper part projects radially into the annular cylindrical intermediate space.

21. The bearing device of claim 20, wherein the magnetic-field-producing means are formed by a winding of an electromagnet.

22. The bearing device of claim 21, further comprising a regulation apparatus for regulating a field current through the electromagnet for adjusting a damping constant of the damping apparatus.

23. The bearing device of claim 22, wherein the regulation apparatus regulates the damping constant as a function of a rotation speed of the bearing device.

24. The bearing device of claim 23, wherein the damping constant assumes a predetermined value at a predetermined rotation speed or at a plurality of predetermined rotation speeds of the bearing device, which are in a region of a resonant frequency or resonant frequencies of the bearing device, in order to suppress resonant oscillations of the bearing device.

25. The bearing device of claim 21, wherein the magnetic-field-producing means are arranged on a radially outer edge area of the second damper part between the two magnetic-flux-guiding side parts.

26. The bearing device of claim 20, wherein the magnetic-field-producing means are formed by at least one permanent magnet.

27. A bearing device comprising:
a shaft magnetically supported for rotation about a rotation axis with respect to a stator, and
a damping apparatus comprising:
at least one perforated disk-shaped first damper part arranged perpendicular to the rotation axis and forming part of the stator, and
at least one yoke body forming a second damper part and being mechanically connected to the shaft, said yoke body comprising:
magnetic-field-producing means, and
two magnetic-flux-guiding side parts, which are spaced from one another in an axial direction with respect to the rotation axis and form an annular cylindrical intermediate space, said side parts having on their sides facing the first damper part tooth-like projections, which are rotationally symmetrical with respect to the rotation axis, said tooth-like projections producing in the annular cylindrical intermediate space a magnetic field that is inhomogeneous in a radial direction with respect to the rotation axis,
wherein the first damper part projects radially into the annular cylindrical intermediate space and completely surrounds the second damper part in the circumferential direction with respect to the rotation axis.

28. The bearing device of claim 27, wherein the second damper part is mechanically connected to the shaft via a non-magnetic reinforcement and magnetically separated from the shaft.

29. The bearing device of claim 27, wherein the shaft is formed from a non-magnetic material.

30. The bearing device of claim 27, wherein the magnetic-field-producing means are formed by at least one permanent magnet.

31. The bearing device of claim 30, wherein the magnetic-field-producing means are formed by a ring magnet surrounding the shaft.

32. The bearing device of claim 30, wherein the magnetic-field-producing means are formed by an arrangement of individual magnets which in conjunction together with the magnetic-flux-guiding side parts form a closed magnetic arrangement which surrounds the shaft in a circumferential direction of the side parts.

33. The bearing device of claim 30, wherein the permanent magnets comprise a material selected from neodymium, iron and boron.

34. The bearing device of claim 30, wherein the magnetic-field-producing means are a component of the two magnetic-flux-guiding side parts.

35. The bearing device of the claim 27, wherein the magnetic bearing device comprises a superconducting material.

36. The bearing device of claim 35, wherein the superconducting material is a low-temperature superconducting material or a high-temperature superconducting material.

37. The bearing device of claim 27, wherein the tooth-like projections have a trapezoidal cross section.

38. The bearing device of claim 27, wherein the first damper part is composed predominantly of copper or aluminum.

39. The bearing device of claim 27, wherein the second damper part is composed predominantly of iron or steel.

40. The bearing device of the claim 20, wherein the magnetic bearing device comprises a superconducting material.

41. The bearing device of claim 40, wherein the superconducting material is a low-temperature superconducting material or a high-temperature superconducting material.

42. The bearing device of claim 20, wherein the tooth-like projections have a trapezoidal cross section.

43. The bearing device of claim 20, wherein the first damper part is composed predominantly of copper or aluminum.

44. The bearing device of claim 20, wherein the second damper part is composed predominantly of iron or steel.
